(19) United States
(12) Patent Application Publication
(10) Pub. No.: US 2014/0278778 A1
(43) Pub. Date: Sep. 18, 2014

(54) METHOD, APPARATUS, AND COMPUTER-READABLE MEDIUM FOR PREDICTING SALES VOLUME

(71) Applicant: Rangespan Limited, London (GB)

(72) Inventor: Ryan Regan, London (GB)

(73) Assignee: Rangespan Limited, London (GB)

(21) Appl. No.: 14/215,905

(22) Filed: Mar. 17, 2014

Related U.S. Application Data
(60) Provisional application No. 61/794,827, filed on Mar. 15, 2013.
(60) Provisional application No. 61/914,944, filed on Dec. 11, 2013.

(51) Int. Cl. G06Q 10/04

(52) U.S. Cl. CPC G06Q 10/04
USPC 705/7.31

(57) ABSTRACT

An apparatus, computer-readable medium, and computer-implemented method for predicting sales volume includes receiving historical sales information corresponding to a plurality of stock keeping units (SKUs), the historical sales information including a sales volume, grouping the plurality of SKUs into a plurality of sales tiers, generating a feature vector for each SKU in the plurality of SKUs, generating a statistical model based at least in part on the plurality of SKUs and their corresponding assigned sales tiers and feature vectors, and determining one or more projected sales tiers corresponding to one or more new SKUs based at least in part on the statistical model.

### RELATED APPLICATION DATA

This application claims priority to U.S. Provisional Application No. 61/794,827, filed Mar. 15, 2013 and U.S. Provisional Application No. 61/914,944, filed Dec. 12, 2013, the disclosures of which are hereby incorporated by reference in their entirety.

### BACKGROUND

A primary challenge for a retailer (an enterprise that sells products to end customers) is to identify which unique products, also referred to as stock-keeping units (“SKUs”), to offer to its customers out of the entire market of unique products available (“product universe”) to source from suppliers. Any inefficiencies in this sourcing exercise by retailers (“ranging” or “buying”) can result in lost sales through not choosing popular products or lost profits through excess inventory by choosing the wrong products.

The sourcing challenge is compounded as advances in technology, primarily in the areas of communications, manufacturing, and logistics, have exponentially expanded both the number of unique products in the product universe, as well as the number of SKUs that an individual retailer can offer to its customers. A mega-retailer such as Amazon.com, can offer its customers over 100 million unique products at any one time compared to more traditional physical store retailers carrying less than 100,000. As the cost of manufacturing and technology continue to decrease over time, the barriers for new suppliers and products to enter a market continue to decrease as well, furthering the expansion of the product universe.

Currently, the option available to a retailer to manage ranging decisions on a much larger scale has been to increase the size of the teams responsible for selecting product ranges (“retail buyers”). Under traditional product selection processes, retail buyers would determine the products to range through a combination of customer feedback (i.e. what have customers bought historically), supplier input (i.e. which products do the suppliers think will sell), and intuition. Each retail buyer has a limited capacity on the number of supplier relationships they can manage (due to working hour constraints), so in order to manage a wider network of suppliers as well as unique products, more retail buyers are needed under the traditional approach. As human productivity is relatively static, this means that as the product universe grows exponentially, costs associated with the buying function will only scale linearly, likely decreasing profitability for retailers over time.

In order to manage the increased product complexity more efficiently, retailers need to become more intelligent and scalable in how they make product range decisions.

### BRIEF DESCRIPTION OF THE DRAWINGS

FIG. 1 illustrates a flowchart for predicting sales volume according to an exemplary embodiment.

FIG. 2 illustrates a flowchart for grouping SKUs into a plurality of sales tiers according to an exemplary embodiment

FIG. 3 illustrates an example of the grouping process on a sample data set according to an exemplary embodiment.

FIG. 4 illustrates a flowchart for generating a statistical model according to an exemplary embodiment.

FIG. 5 illustrates a process flow diagram for training and updating the statistical model according to an exemplary embodiment.

FIG. 6 illustrates a user interface for retail buyers according to an exemplary embodiment.

FIG. 7 illustrates an exemplary computing environment that can be used to carry out the method for predicting sales volume according to an exemplary embodiment.

### DETAILED DESCRIPTION

While methods, apparatuses, and computer-readable media are described herein by way of examples and embodiments, those skilled in the art recognize that methods, apparatuses, and computer-readable media for predicting sales volumes are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Applicant has discovered and developed new technology and processes to allow retailers to quickly and efficiently make product decisions across a growing product universe of hundreds of millions of unique products, as well as reduce the risks associated with product adoption, by generating a product forecast for each unique SKU.

Applicant has developed a forecasting methodology that predicts the likelihood that a unique product or SKU will be popular (i.e. be purchased) with future customers. This allows retailers to adopt products in a manner that maximizes sales and profits by ensuring that they offer the products that their customers desire.

Additionally, Applicant has developed an interface that allows a retail buyer to evaluate and add/adopt products across the millions of products in the product universe, currently commercially referred to as the Search Engine for Buyers. The foundational approach to both elements is using properties or facts inherent to the individual products (“attributes”) as a guide to identify which products to adopt.

The present application discloses a sales tier metric (commercially called “RangeRank”) that is projected for each unique product, or SKU, as an indicator of projected product popularity of that product with end customers. For the purposes of the sales tier metric described herein, product popularity is measured by turnover (volume sold). In other words, if product A has a projected sales tier (i.e., RangeRank) of 1 and product B has a projected sales tier of 2, we can expect product A to generate more turnover than product B. Of course, the sales tier can be based on other indicators of popularity, including revenues from the product, profits, and the like.

Additionally, sales history (historical sales volume) can be estimated by ranking SKUs based on a particular web property, for example search rank, or any other property which is correlated with sales volume (turnover). After ranking the SKUs, the ranked SKUs can be fit to a standard probability distribution (such as a Pareto distribution) and the position of each SKU on the distribution can be used to estimate historical sales volume for that SKU. This technique can be used to supplement actual sales information or used in the event that actual sales information is unavailable for a particular SKU.

FIG. 1 is flowchart showing a method of predicting sales volume according to an exemplary embodiment. At step 101, historical sales information corresponding to a plurality of stock keeping units (SKUs) is received. The historical sales information can include a sales volume for each SKU in the plurality of SKUs as well as any additional attributes associated with the SKUs. The plurality of SKUS can correspond to a subset of products in the product universe that have been available for purchase by end customers. The historical sales information can be received from any source, including retailer sales databases, consumer purchase databases, advertiser databases, data aggregators, and/or any other data sources which store or have access to historical sales information for products. Additionally, historical sales information can be combined from multiple retailers to generate a global set of sales data with which to build training set.

The received historical sales information can also be filtered to remove any anomalies or other data that is undesirable for training purposes, resulting in a subset of the sales data that is received being used for training. Additionally, the historical sales information can be filtered to a specific date range. For example, the received historical sales information can be filtered to only historical sales information for the past 5 years, in order to more accurately capture recent sales trends.

The received historical sales information can be separated into multiple training sets, depending on categories of products. So, for example, a first training set can contain historical sales information for products in electronics, and a second training set can contain historical sales information for children's toys. Additionally, this step can be done automatically by keeping the historical sales information from certain retailers separate from other retailers. Using the earlier example, historical sales information from an electronics store would be kept separate from historical sales information from a toy store.

At step 102, the plurality of SKUs are grouped into a plurality of sales tiers, with each SKU being assigned to a sales tier in the plurality of sales tiers and each sales tier corresponding to a range of sales volumes. This process is explained in greater detail with reference to FIGS. 2 and 3.

Turning to FIG. 2, at step 201, an ordered list of SKUs is generated by sorting the plurality of SKUs by the sales volume associated with each SKU. At step 202, a list of cumulative sales volumes corresponding to the ordered list of SKUs is generated based on the sales volume for each SKU in the ordered list of SKUs, with each SKU in the ordered list of SKUs corresponding to a cumulative sales volume in the list of cumulative sales volumes.

At step 203, the ordered list of SKUs are grouped into a plurality of sales tiers based at least in part on the corresponding cumulative sales volume for each SKU. As shown in FIG. 2, Step 203 can be broken down into two sub-steps. At step 203A, the list of cumulative sales volumes are separated into a plurality of cumulative volume tiers based on one or more cumulative volume thresholds. At step 203B, each SKU in the ordered list of SKUs is grouped into a sales tier in the plurality of sales tiers based on which cumulative volume tier the cumulative sales volume corresponding to the SKU falls within.

To provide an illustrative example, FIG. 3 shows a table 301 of ten SKUs with corresponding sales volume for each. So, for example, SKU #2 has a sales volume (turnover) of 7 units. The ten SKUs can be sorted by sales volume as shown in table 302. The SKUs are shown sorted from highest sales volume to lowest sales volume, but can also be sorted from lowest sales volume to highest sale volume. Also shown in table 302 is a list of cumulative sales volumes corresponding to the sorted list of SKUs. So, for example, third entry on the table has an SKU # of 9, a sales volume of 6, and a cumulative sales volume of 23.

The SKUs are shown plotted against the cumulative sales volumes in graph 303. The SKUs are then grouped into four categories corresponding to four sales tiers, shown as areas 303A, 303B, 303C, and 303D on graph 303, based on cumulative volume thresholds of 20 for the first sales tier, 27 for the second sales tier, and 31 for the third sales tier. Additionally, SKUs with no sales volume (zero turnover) are grouped into the fourth sales tier. As shown in the figure, a lower sales tier corresponds to higher sales volume and a higher sales tier corresponds to lower sales volume. Of course, if the SKUs are sorted in increasing rather than decreasing order, the sales tiers can be reversed, with a lower sales tier corresponding to a lower sales volume and a higher sales tier corresponding to a higher sales volume.

Although four sales tiers are described in the example above, these groupings can be replaced with a more granular scale. For example, the SKUs can be grouped into ten sales tiers, or three sales tiers corresponding to high, medium, and low sales volume. Additionally, the number of sales tiers can be specified by a user based one on or more preferences.

The number of sales tiers can also be dependent on the product category. For example, more expensive categories of products can use fewer categories since the overall sales volume is likely lower, and less expensive products can use a greater number of categories as the overall sales volume is likely higher.

The thresholds for dividing SKUs into sales tiers can also be applied to the individual sales volumes for the SKUs and not just the cumulative volumes. Additionally, the thresholds can be automatically determined based on product categories, the number of sales tiers for grouping SKUs, statistical analysis, historical data relating to most accurate thresholds, or any other computational method. The thresholds can be set, adjusted, or configured by a user as well. Additionally, the threshold can be adjusted or calibrated over time, using a feedback loop that assesses how accurate the sales tier produced by the particular threshold is predicting sales.

Returning to FIG. 1, at step 103 a feature vector is generated for each SKU in the plurality of SKUs, each feature vector including a subset of a plurality of attributes associated with each SKU.

The goal of this step is to identify the attributes of a product that are predictive of a particular sales tier by selecting one or more attributes from the plurality of attributes associated with each SKU. This set of features is referred to as the feature vector for the SKU.

The feature vector can be determined by analyzing the attributes of the SKUs in the historical sales information and selecting one or more of the attributes as features. In other words, each of the attributes of the SKUs in the historical sales information is a potential feature.

The determination of whether any particular attribute should be a feature in the feature vector can based on a frequency of occurrence of an attribute among the plurality of SKUs (such as how common the attribute is among SKUs), a determination that at least a predetermined percentage of SKUs have an attribute (such as whether most or all SKUs have the attribute), a determination that an attribute does not directly determine a sales tier (attributes that directly determine a sales tier, such as sales value, can be avoided since the purpose of feature extraction is to identify other attributes that determine sales volume), a determination that an attribute is correlated with a sales tier (for example, the attribute “cost” can have a correlation with sales tiers); a degree of correlation between an attribute and a sales tier (such as whether the correlation is strong, average, or weak), a determination that a combination of attributes are correlated with a sales tier (for example, the combination of the attributes “manufacturer” and “cost” can have a correlation with sales tiers), a degree of correlation between a combination of attributes and a sales tier (such as whether the correlation is strong, average or weak), or any other suitable measure.

Some candidate attributes that can be used as features include the SKU's manufacturer, the SKU's category, the SKU's cost, the price difference in cost between a retail supplier and competitors, the price difference between any two vendors, how long the SKU has been live on a retailers site, whether the SKU has an offer today, the average sentiment of consumer reviews for this SKU, average ratings for the SKU, number of returns of the SKU product, the number of search engine results for this SKU, indications of demand from other retailers.

Of course, these attributes are provided for illustration only and the list of attributes can grow and change over time. A feature in the feature vector can be numeric and/or textual. Additionally, the attributes and features can be processed prior to generation of a feature vector. For example, costs can be bucketed into segments cost<10, 10<cost<100, 100<cost, so that the cost is represented as one of three values (low, medium, high).

Returning to FIG. 1, at step 104, a statistical model is generated based at least in part on the plurality of SKUs and their corresponding assigned sales tiers and feature vectors. Probabilistic methods that learn patterns that are correlated with sales tier are utilized. Generally, this is known as “learning to rank” area in machine learning and statistics. Both the choice of features and feature transformations in the feature vector generation step, as well as the choice of statistical model, determine the accuracy of sales tier predictions. Accordingly, the feature vectors and the statistical model used can be adjusted or changed to improve prediction of sales tiers. The model generation process is explained in greater detail with reference to FIG. 4.

As shown in FIG. 4, at step 401, the plurality of SKUs are randomly ordered to generate a randomized set of SKUs. This step can optionally be omitted. At step 402, the statistical model is trained on one or more first subsets of SKUs in the randomized set of SKUs. If the randomizing step is omitted, step 402 and the following steps can be performed on plurality of SKUs as previously ordered.

The training step can include updating the statistical model based on a correlation between a feature vector for the SKU and an assigned sales tier for the SKU. For example, if the feature vector for the SKU includes a manufacturer attribute and the value of the attribute is “Company XYZ” and the sales tier for SKU is sales tier 1 (RangeRank 1), then the model can be updated to more closely associate SKUs having a manufacturer attribute of “Company XYZ” with sales tier 1.

At step 403, the statistical model is applied to one or more second subsets of SKUs in the randomized set of SKUs to generate a predicted sales tier for each SKU in the one or more second subsets of SKUs. The predicted sales tier for the SKUs can be based on the statistical model and a feature vector for the SKUs. In other words, the feature vector for the SKUs can be input to the statistical model to generate a predicted sales tier. Since the assigned sales tiers for the SKUs are known, the predicted sales tiers can be compared to the assigned sales tiers and the statistical model can be updated if the predicted sales tier is not equal to an assigned sales tier for a particular SKU. For example, the statistical model can be trained on Product A and Product B, and used to predict the sales tier for Product C based on the feature vector for Product C. If the model predicts sales tier 3 and Product C has an assigned sales tier of 2, then the model can be updated or otherwise calibrated to adjust for the error.

At step 404, the accuracy of the statistical model is determined by comparing each predicted sales tier to an assigned sales tier for each SKU in the one or more second subsets of SKUs.

FIG. 5 illustrates a process flow diagram for generating and training the statistical model according to an exemplary embodiment. As indicated earlier, the plurality of SKUs can first be randomly sorted to generate a randomized list. At step 501, the model is trained on the 1^{st} through N^{th} SKUs. Since N is initially set to 1, the model is first trained on the 1^{st} SKU. At step 502, the sales tier for the (N+1)^{th} SKU is predicted. Initially, this means that the sales tier for the 2^{nd} SKU is predicted.

At step 503, it is determined whether the prediction is correct. Since the assigned sales tiers for each SKU are already known, this can be accomplished by comparing the predicted SKU to the assigned SKU. If the prediction is not correct, the statistical model can be updated at step 504. Regardless of whether the prediction is correction, the result of the comparison can be recorded, including any errors. For example, a confusion table can be used to store the result of the comparisons.

At step 505, N is incremented by one and the process then goes to step 501 and is repeated. In the second iteration, since N=2, this means that the statistical model can be trained on the 1^{st} and 2^{nd} SKUs, and the model can be applied to the feature vector for the 3^{rd} SKU to predict the sales tier for the 3^{rd} SKU. The process can repeat until all of the SKUs have been incorporated and/or until the model reaches a predetermined level of accuracy.

At the end of these steps, the result is both a statistical model and an estimate of the accuracy of the statistical model in predicting sales tiers for SKUs.

The accuracy information can be used to generate a confusion table (also called a confusion matrix) where cell (X, Y) represents how many SKUs had sales tier X in the training set but for which the statistical model predicted sales tier Y. A sample confusion table is shown below.

TABLE 1
Sample Confusion Table

| | Predicted | | | |
|---|---|---|---|---|
| True | Sales Tier 1 | Sales Tier 2 | Sales Tier 3 | Sales Tier 4 |
| Sales Tier 1 | 2 | 1 | 0 | 0 |
| Sales Tier 2 | 0 | 1 | 0 | 0 |
| Sales Tier 3 | 0 | 0 | 1 | 0 |
| Sales Tier 4 | 0 | 0 | 1 | 2 |

So, for example, using the above confusion table, of the three items that had a sales tier of 1, the algorithm predicted that two items had a sales tier of 1 and one item had a sales tier of 2. Of the three items that had a sales tier of 4, the algorithm predicted that one item had a sales tier of 3 and two items had a sales tier of 4.

The property desired in a confusion table is that most high counts live on the diagonal, meaning that most sales tiers predictions are correct. Since there is not always a strict ordering of confusion tables, they can be summarize into single values using metrics such as Kendall's Tau.

As discussed earlier, after incorrect prediction steps and subsequent error calculation steps, the statistical model can be adjusted, replaced with a different model, or calibrated to better predict sales tier. The confusion table can be used for evaluation of the effectiveness of the model and/or feature vectors.

Returning to FIG. 1, at step 105, one or more projected sales tiers are determined for one or more new SKUs based at least in part on the statistical model, with each projected sales tier in the one or more projected sales tiers corresponding to a range of projected sales volumes. This can include generating feature vectors for each new SKU in the one or more new SKUs and determining a projected sales tier for each new SKU in the one or more new SKUs using the statistical model and the new feature vector corresponding to the new SKU.

This step applies the statistical model to SKUs that are not in the training set in order to effectively predict the sales volume and popularity of each of the SKUs in terms of sales tier (RangeRank). The feature vector generated for each of the new SKUs should include the same attributes as those generated during the training of the statistical model.

The projected sales tier outputted by the statistical model for each of the new SKUs can be considered an estimate of how much the SKU would sell if it were launched on a retail partner's website. In addition to the projected sales tier, a user can optionally be provided with a confidence value, based on the earlier determined accuracy of the model for each sales tier.

This cycle can then be repeated over time to refresh and improve predictability. New sales information can be used to continuously inform the statistical model and improve the sales tier predictions.

Turning to FIG. 6, an interface 601 for retail buyers to view, sort, and select SKUs is shown. The interface 601 can display a plurality of SKUs 602 in a product catalog corresponding to some subset of the product universe. The product catalog assigns a unique identifier to each product and also contains attributes or facts about each individual product (these can overlap with attributes used in determining sales tier). These attributes can include product categorization, manufacturer, images, cost price, selling prices at competitors, projected sales tier (indicated as RangeRank), price point, inventory availability from suppliers, and any other attributes common to products within a given product category or categories (i.e. color).

The interface allows a retail buyer to rapidly filter products to attributes that meet their criteria for further investigation or ultimate adoption. Additionally, retail buyers can leverage projected (or historical) sales tiers (RangeRank—603 in the figure) to select and view SKUs that are projected to have high turnover (or have historically high turnover). For example, a selection of a sales tier in the plurality of sales tiers can be determined based on an input, such as the user selecting one of the “RangeRank” indicators 603. The interface can then transmit the SKUs which have a projected sales tier corresponding to the selected sales tier or remove the SKUs which have a projected sales tier corresponding to the de-selected sales tier, depending on the input.

In the interface 601, the right hand navigation includes examples of the attribute filters that a buyer can use to focus their product research. In this specific case, they have focused on the camera subcategory of the product universe, with further filters on popularity (sales tier/Range Rank 1, 2, 3), cost price relative to competition, and inventory availability through a supplier (“On Rangespan”), but not currently on offer by the retail (“Not on Argos”). As described above, the exhaustive list of attributes that the product universe can be filtered on can and will change over time. With these filters in place, the buyer can then see the 101 products that meet these criteria, and take action to research further or chose to adopt.

This approach allows buyers to focus on the qualities of products, as well as easily compare similar products across thousands of suppliers and individual products. In addition, using attribute based research, retailers can make range decisions across millions of products, something that is not cost effective without the help of technology.

One or more of the above-described techniques can be implemented in or involve one or more computer systems. FIG. 7 illustrates a generalized example of a computing environment 700. The computing environment 700 is not intended to suggest any limitation as to scope of use or functionality of a described embodiment.

With reference to FIG. 7, the computing environment 700 includes at least one processing unit 710 and memory 720. The processing unit 710 executes computer-executable instructions and may be a real or a virtual processor. In a multi-processing system, multiple processing units execute computer-executable instructions to increase processing power. The memory 720 may be volatile memory (e.g., registers, cache, RAM), non-volatile memory (e.g., ROM, EEPROM, flash memory, etc.), or some combination of the two. The memory 720 may store software instructions 780 for implementing the described techniques when executed by one or more processors. Memory 720 can be one memory device or multiple memory devices.

A computing environment may have additional features. For example, the computing environment 700 includes storage 740, one or more input devices 750, one or more output devices 760, and one or more communication connections 790. An interconnection mechanism 770, such as a bus, controller, or network interconnects the components of the computing environment 700. Typically, operating system software or firmware (not shown) provides an operating environment for other software executing in the computing environment 700, and coordinates activities of the components of the computing environment 700.

The storage 740 may be removable or non-removable, and includes magnetic disks, magnetic tapes or cassettes, CD-ROMs, CD-RWs, DVDs, or any other medium which can be used to store information and which can be accessed within the computing environment 700. The storage 740 may store instructions for the software 780.

The input device(s) 750 may be a touch input device such as a keyboard, mouse, pen, trackball, touch screen, or game controller, a voice input device, a scanning device, a digital camera, remote control, or another device that provides input to the computing environment 700. The output device(s) 760 may be a display, television, monitor, printer, speaker, or another device that provides output from the computing environment 700.

The communication connection(s) 790 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 700, computer-readable media include memory 720, storage 740, communication media, and combinations of any of the above.

Of course, FIG. 7 illustrates computing environment 700, display device 760, and input device 750 as separate devices for ease of identification only. Computing environment 700, display device 760, and input device 750 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 700 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for predicting sales volume, the method comprising:
receiving, by at least one of the one or more computing devices, historical sales information corresponding to a plurality of stock keeping units (SKUs), the historical sales information including a sales volume for each SKU in the plurality of SKUs;
grouping, by at least one of the one or more computing devices, the plurality of SKUs into a plurality of sales tiers, wherein each SKU is assigned to a sales tier in the plurality of sales tiers and wherein each sales tier corresponds to a range of sales volumes;
generating, by at least one of the one or more computing devices, a feature vector for each SKU in the plurality of SKUs, wherein each feature vector comprises a subset of a plurality of attributes associated with each SKU;
generating, by at least one of the one or more computing devices, a statistical model based at least in part on the plurality of SKUs and their corresponding assigned sales tiers and feature vectors; and
determining, by at least one of the one or more computing devices, one or more projected sales tiers corresponding to one or more new SKUs based at least in part on the statistical model, wherein each projected sales tier in the one or more projected sales tiers corresponds to a range of projected sales volumes.

2. The method of claim 1, wherein grouping the plurality of SKUs into a plurality of sales tiers comprises:
generating an ordered list of SKUs by sorting the plurality of SKUs by sales volume;
generating a list of cumulative sales volumes corresponding to the ordered list of SKUs based on the sales volume for each SKU in the ordered list of SKUs, wherein each SKU in the ordered list of SKUs corresponds to a cumulative sales volume in the list of cumulative sales volumes; and
grouping the ordered list of SKUs into a plurality of sales tiers based at least in part on the corresponding cumulative sales volume for each SKU.

3. The method of claim 2, wherein grouping the ordered list of SKUs comprises,
separating the list of cumulative sales volumes into a plurality of cumulative volume tiers based on one or more cumulative volume thresholds;
grouping each SKU in the ordered list of SKUs into a sales tier in the plurality of sales tiers based on which cumulative volume tier the cumulative sales volume corresponding to the SKU falls within.

4. The method of claim 2, wherein generating an ordered list of SKUs by sorting the plurality of SKUs by sales volume comprises sorting the plurality of SKUs from highest sales volume to lowest sales volume.

5. The method of claim 1, wherein generating a feature vector for each SKU in the plurality of SKUs comprises selecting one or more attributes from the plurality of attributes associated with each SKU based on at least one of a frequency of occurrence of an attribute among the plurality of SKUs, a determination that at least a predetermined percentage of SKUs have an attribute, a determination that an attribute does not directly determine a sales tier, a determination that an attribute is correlated with a sales tier, a degree of correlation between an attribute and a sales tier, a determination that a combination of attributes are correlated with a sales tier, and a degree of correlation between a combination of attributes and a sales tier.

6. The method of claim 1, wherein generating a statistical model based at least in part on the plurality of SKUs and their corresponding assigned sales tiers and feature vectors comprises:
randomly ordering the plurality of SKUs to generate a randomized set of SKUs;
training the statistical model on one or more first subsets of SKUs in the randomized set of SKUs;
applying the statistical model to one or more second subsets of SKUs in the randomized set of SKUs to generate a predicted sales tier for each SKU in the one or more second subsets of SKUs; and
determining an accuracy of the statistical model by comparing each predicted sales tier to an assigned sales tier for each SKU in the one or more second subsets of SKUs.

7. The method of claim 6, wherein training the statistical model on one or more first subsets of SKUs comprises:
updating, for at least one SKU in the one or more first subsets of SKUs, the statistical model based on a correlation between a feature vector for the at least one SKU and an assigned sales tier for the at least one SKU.

8. The method of claim 6, wherein applying the statistical model to one or more second subsets of SKUs comprises:
generating, for at least one SKU in the one or more second subsets of SKUs, the predicted sales tier based at least in part on the statistical model and a feature vector corresponding to the at least one SKU; and
updating, for the at least one SKU in the one or more second subsets of SKUs, the statistical model based at least in part on a determination that the predicted sales tier is not equal to an assigned sales tier for the at least one SKU.

9. The method of claim 1, wherein determining the one or more projected sales tiers corresponding to one or more new SKUs comprises:
generating a new feature vector for each new SKU in the one or more new SKUs; and
determining a projected sales tier for each new SKU in the one or more new SKUs based at least in part on the statistical model and the new feature vector corresponding to the new SKU.

10. The method of claim 1, further comprising:
identifying, by at least one of the one or more computing devices, a selection of a sales tier in the plurality of sales tiers based on an input; and
transmitting, by at least one of the one or more computing devices, at least one new SKU in the one or more new SKUs which has a projected sales tier corresponding to the selected sales tier.

11. An apparatus for predicting sales volume, the system comprising:
one or more processors; and
one or more memories operatively coupled to at least one of the one or more processors and having instructions stored thereon that, when executed by at least one of the one or more processors, cause at least one of the one or more processors to:
receive historical sales information corresponding to a plurality of stock keeping units (SKUs), the historical sales information including a sales volume for each SKU in the plurality of SKUs;
group the plurality of SKUs into a plurality of sales tiers, wherein each SKU is assigned to a sales tier in the plurality of sales tiers and wherein each sales tier corresponds to a range of sales volumes;
generate a feature vector for each SKU in the plurality of SKUs, wherein each feature vector comprises a subset of a plurality of attributes associated with each SKU;
generate a statistical model based at least in part on the plurality of SKUs and their corresponding assigned sales tiers and feature vectors; and
determine one or more projected sales tiers corresponding to one or more new SKUs based at least in part on the statistical model, wherein each projected sales tier in the one or more projected sales tiers corresponds to a range of projected sales volumes.

12. The apparatus of claim 11, wherein the instructions that, when executed by at least one of the one or more processors, cause at least one of the one or more processors to group the plurality of SKUs into a plurality of sales tiers further cause at least one of the one or more processors to:
generate an ordered list of SKUs by sorting the plurality of SKUs by sales volume;
generate a list of cumulative sales volumes corresponding to the ordered list of SKUs based on the sales volume for each SKU in the ordered list of SKUs, wherein each SKU in the ordered list of SKUs corresponds to a cumulative sales volume in the list of cumulative sales volumes; and
group the ordered list of SKUs into a plurality of sales tiers based at least in part on the corresponding cumulative sales volume for each SKU.

13. The apparatus of claim 12, wherein the instructions that, when executed by at least one of the one or more processors, cause at least one of the one or more processors to group the ordered list of SKUs further cause at least one of the one or more processors to:
separate the list of cumulative sales volumes into a plurality of cumulative volume tiers based on one or more cumulative volume thresholds;
group each SKU in the ordered list of SKUs into a sales tier in the plurality of sales tiers based on which cumulative volume tier the cumulative sales volume corresponding to the SKU falls within.

14. The apparatus of claim 12, wherein the instructions that, when executed by at least one of the one or more processors, cause at least one of the one or more processors to generate an ordered list of SKUs by sorting the plurality of SKUs by sales volume further cause at least one of the one or more processors to:
sort the plurality of SKUs from highest sales volume to lowest sales volume.

15. The apparatus of claim 11, wherein the instructions that, when executed by at least one of the one or more processors, cause at least one of the one or more processors to generate a feature vector for each SKU in the plurality of SKUs further cause at least one of the one or more processors to:
select one or more attributes from the plurality of attributes associated with each SKU based on at least one of a frequency of occurrence of an attribute among the plurality of SKUs, a determination that at least a predetermined percentage of SKUs have an attribute, a determination that an attribute does not directly determine a sales tier, a determination that an attribute is correlated with a sales tier, a degree of correlation between an attribute and a sales tier, a determination that a combination of attributes are correlated with a sales tier, and a degree of correlation between a combination of attributes and a sales tier.

16. The apparatus of claim 11, wherein the instructions that, when executed by at least one of the one or more processors, cause at least one of the one or more processors to generate a statistical model based at least in part on the plurality of SKUs and their corresponding assigned sales tiers and feature vectors further cause at least one of the one or more processors to:
randomly order the plurality of SKUs to generate a randomized set of SKUs;
train the statistical model on one or more first subsets of SKUs in the randomized set of SKUs;
apply the statistical model to one or more second subsets of SKUs in the randomized set of SKUs to generate a predicted sales tier for each SKU in the one or more second subsets of SKUs; and
determine an accuracy of the statistical model by comparing each predicted sales tier to an assigned sales tier for each SKU in the one or more second subsets of SKUs.

17. The apparatus of claim 16, wherein the instructions that, when executed by at least one of the one or more processors, cause at least one of the one or more processors to train the statistical model on one or more first subsets of SKUs further cause at least one of the one or more processors to:
update, for at least one SKU in the one or more first subsets of SKUs, the statistical model based on a correlation between a feature vector for the at least one SKU and an assigned sales tier for the at least one SKU.

18. The apparatus of claim 16, wherein the instructions that, when executed by at least one of the one or more processors, cause at least one of the one or more processors to apply the statistical model to one or more second subsets of SKUs further cause at least one of the one or more processors to:
generate, for at least one SKU in the one or more second subsets of SKUs, the predicted sales tier based at least in part on the statistical model and a feature vector corresponding to the at least one SKU; and
update, for the at least one SKU in the one or more second subsets of SKUs, the statistical model based at least in part on a determination that the predicted sales tier is not equal to an assigned sales tier for the at least one SKU.

19. The apparatus of claim 11, wherein the instructions that, when executed by at least one of the one or more processors, cause at least one of the one or more processors to determine the one or more projected sales tiers corresponding to one or more new SKUs further cause at least one of the one or more processors to:
generate a new feature vector for each new SKU in the one or more new SKUs; and
determine a projected sales tier for each new SKU in the one or more new SKUs based at least in part on the statistical model and the new feature vector corresponding to the new SKU.

20. The apparatus of claim 11, wherein at least one of the one or more memories has further instructions stored thereon that, when executed by at least one of the one or more processors, cause at least one of the one or more processors to:
identify a selection of a sales tier in the plurality of sales tiers based on an input; and
transmit at least one new SKU in the one or more new SKUs which has a projected sales tier corresponding to the selected sales tier.

21. At least one non-transitory computer-readable medium storing computer-readable instructions that, when executed by one or more computing devices, cause at least one of the one or more computing devices to:
receive historical sales information corresponding to a plurality of stock keeping units (SKUs), the historical sales information including a sales volume for each SKU in the plurality of SKUs;
group the plurality of SKUs into a plurality of sales tiers, wherein each SKU is assigned to a sales tier in the plurality of sales tiers and wherein each sales tier corresponds to a range of sales volumes;
generate a feature vector for each SKU in the plurality of SKUs, wherein each feature vector comprises a subset of a plurality of attributes associated with each SKU;
generate a statistical model based at least in part on the plurality of SKUs and their corresponding assigned sales tiers and feature vectors; and
determine one or more projected sales tiers corresponding to one or more new SKUs based at least in part on the statistical model, wherein each projected sales tier in the one or more projected sales tiers corresponds to a range of projected sales volumes.

22. The at least one non-transitory computer-readable medium of claim 21, wherein the instructions that, when executed by at least one of the one or more computing devices, cause at least one of the one or more computing devices to group the plurality of SKUs into a plurality of sales tiers further cause at least one of the one or more computing devices to:
generate an ordered list of SKUs by sorting the plurality of SKUs by sales volume;
generate a list of cumulative sales volumes corresponding to the ordered list of SKUs based on the sales volume for each SKU in the ordered list of SKUs, wherein each SKU in the ordered list of SKUs corresponds to a cumulative sales volume in the list of cumulative sales volumes; and
group the ordered list of SKUs into a plurality of sales tiers based at least in part on the corresponding cumulative sales volume for each SKU.

23. The at least one non-transitory computer-readable medium of claim 22, wherein the instructions that, when executed by at least one of the one or more computing devices, cause at least one of the one or more computing devices to group the ordered list of SKUs further cause at least one of the one or more computing devices to:
separate the list of cumulative sales volumes into a plurality of cumulative volume tiers based on one or more cumulative volume thresholds;
group each SKU in the ordered list of SKUs into a sales tier in the plurality of sales tiers based on which cumulative volume tier the cumulative sales volume corresponding to the SKU falls within.

24. The at least one non-transitory computer-readable medium of claim 22, wherein the instructions that, when executed by at least one of the one or more computing devices, cause at least one of the one or more computing devices to generate an ordered list of SKUs by sorting the plurality of SKUs by sales volume further cause at least one of the one or more computing devices to:
sort the plurality of SKUs from highest sales volume to lowest sales volume.

25. The at least one non-transitory computer-readable medium of claim 21, wherein the instructions that, when executed by at least one of the one or more computing devices, cause at least one of the one or more computing devices to generate a feature vector for each SKU in the plurality of SKUs further cause at least one of the one or more computing devices to:
select one or more attributes from the plurality of attributes associated with each SKU based on at least one of a frequency of occurrence of an attribute among the plurality of SKUs, a determination that at least a predetermined percentage of SKUs have an attribute, a determination that an attribute does not directly determine a sales tier, a determination that an attribute is correlated with a sales tier, a degree of correlation between an attribute and a sales tier, a determination that a combination of attributes are correlated with a sales tier, and a degree of correlation between a combination of attributes and a sales tier.

26. The at least one non-transitory computer-readable medium of claim 21, wherein the instructions that, when executed by at least one of the one or more computing devices, cause at least one of the one or more computing devices to generate a statistical model based at least in part on the plurality of SKUs and their corresponding assigned sales tiers and feature vectors further cause at least one of the one or more computing devices to:
randomly order the plurality of SKUs to generate a randomized set of SKUs;
train the statistical model on one or more first subsets of SKUs in the randomized set of SKUs;
apply the statistical model to one or more second subsets of SKUs in the randomized set of SKUs to generate a predicted sales tier for each SKU in the one or more second subsets of SKUs; and
determine an accuracy of the statistical model by comparing each predicted sales tier to an assigned sales tier for each SKU in the one or more second subsets of SKUs.

27. The at least one non-transitory computer-readable medium of claim 26, wherein the instructions that, when executed by at least one of the one or more computing devices, cause at least one of the one or more computing devices to train the statistical model on one or more first subsets of SKUs further cause at least one of the one or more computing devices to:
update, for at least one SKU in the one or more first subsets of SKUs, the statistical model based on a correlation between a feature vector for the at least one SKU and an assigned sales tier for the at least one SKU.

28. The at least one non-transitory computer-readable medium of claim 26, wherein the instructions that, when executed by at least one of the one or more computing devices, cause at least one of the one or more computing devices to apply the statistical model to one or more second subsets of SKUs further cause at least one of the one or more computing devices to:
generate, for at least one SKU in the one or more second subsets of SKUs, the predicted sales tier based at least in part on the statistical model and a feature vector corresponding to the at least one SKU; and
update, for the at least one SKU in the one or more second subsets of SKUs, the statistical model based at least in part on a determination that the predicted sales tier is not equal to an assigned sales tier for the at least one SKU.

29. The at least one non-transitory computer-readable medium of claim 21, wherein the instructions that, when executed by at least one of the one or more computing devices, cause at least one of the one or more computing devices to determine the one or more projected sales tiers corresponding to one or more new SKUs further cause at least one of the one or more computing devices to:
generate a new feature vector for each new SKU in the one or more new SKUs; and
determine a projected sales tier for each new SKU in the one or more new SKUs based at least in part on the statistical model and the new feature vector corresponding to the new SKU.

30. The at least one non-transitory computer-readable medium of claim 21, further storing computer-readable instructions that, when executed by at least one of the one or more computing devices, cause at least one of the one or more computing devices to:
identify a selection of a sales tier in the plurality of sales tiers based on an input; and
transmit at least one new SKU in the one or more new SKUs which has a projected sales tier corresponding to the selected sales tier.
